(19) United States
(12) Patent Application Publication
(10) Pub. No.: US 2013/0009875 A1
(43) Pub. Date: Jan. 10, 2013

(54) THREE-DIMENSIONAL COMPUTER INTERFACE

(76) Inventors: Walter G. Fry, Houston, TX (US); William A. Curtis, Austin, TX (US)

(21) Appl. No.: 13/177,472

(22) Filed: Jul. 6, 2011

(51) Int. Cl. G06F 3/042; G06F 3/02

(52) U.S. Cl. 345/168; 345/175

(57) ABSTRACT

Techniques are disclosed relating to a three-dimensional computer interface. In one embodiment, an apparatus is disclosed that includes a camera and a proximity sensor. The camera is configured to capture an image that includes an object. In some embodiments, the proximity sensor is configured to perform a measurement operation that includes determining only a single distance value for the object. The apparatus is configured to calculate a location of the object based on the captured image and the single distance value. In some embodiments, the apparatus is configured to determine a motion of the object by calculating a plurality of locations of the object. In some embodiments, the apparatus is configured to identify the object as a user's hand, and to control a depiction of content on a display based on the determined path of motion for the user's hand.

### BACKGROUND

1. Technical Field

This disclosure relates generally to computers, and, more specifically, to computer interfaces.

2. Description of the Related Art

Modern computing devices may use any of a variety of input devices to receive input from a user. Examples of some input devices include a keyboard, mouse, track pad, camera, etc. While such devices may provide an excellent way for a user to interact with a two-dimensional environment, they do not always provide an excellent way to interact with a three-dimensional environment.

As a result, designers have developed various forms of three-dimensional interfaces. A three-dimensional mouse is one example of a three-dimensional interface that allows a user to interact with a three-dimensional environment. Other examples include a stereoscopic camera (which uses two cameras to capture an image from multiple angles) and an infrared (IR) depth camera (which projects infrared light on an object and captures the reflected light to determine multiple distance values simultaneously).

### SUMMARY OF EMBODIMENTS

The present disclosure describes systems and methods relating to three-dimensional computer interfaces.

In one embodiment, an apparatus is disclosed. The apparatus includes a camera and a sensor. The camera is configured to capture a two-dimensional image that includes an object. The sensor is configured to perform a measurement operation that includes determining only a single distance value for the object, where the single distance value is indicative of a distance to the object. The apparatus is configured to calculate a location of the object based on the captured image and the single distance value.

In another embodiment, a method is disclosed. The method includes a device capturing an image that includes an object located within 1 m of the device. The method further includes the device using a sensor to perform a measurement operation in which only a single distance to the object is determined. The method further includes the device calculating a location of the object based on the captured image and the single distance.

In yet another embodiment, an apparatus is disclosed. The apparatus includes a camera and an electromagnetic proximity sensor. The camera is configured to capture an image that includes an object. The electromagnetic proximity sensor is configured to measure a distance to the object. The apparatus is configured to calculate a location of the object based on the captured image and the measured distance.

### BRIEF DESCRIPTION OF THE DRAWINGS

FIG. 1A is a diagram illustrating one embodiment of a device that is configured to implement a three-dimensional computer interface.

FIG. 1B is a diagram illustrating another embodiment of a device that is configured to implement a three-dimensional computer interface.

FIG. 1C is a diagram illustrating yet another embodiment of a device that is configured to implement a three-dimensional computer interface.

FIG. 2 is a set of diagrams illustrating operation of a camera and a proximity sensor to calculate a location of an object in one embodiment.

FIG. 3 is a diagram illustrating an exemplary path of motion for an object in one embodiment.

FIG. 4 is a block diagram illustrating one embodiment of a power control unit.

FIG. 5 is a flow diagram illustrating one embodiment of a method for calculating the location of an object.

FIG. 6 is a block diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Processor.” This term has its ordinary and accepted meaning in the art, and includes a device that is capable of executing instructions. A processor may refer, without limitation, to a central processing unit (CPU), a co-processor, an arithmetic processing unit, a graphics processing unit, a digital signal processor (DSP), etc. A processor may be a superscalar processor with a single or multiple pipelines. A processor may include a single or multiple cores that are each configured to execute instructions.

The present disclosure recognizes that prior three-dimensional interfaces have some drawbacks. Such interfaces can be costly and are not typically prevalent in personal devices. Stereoscopic cameras and infrared depth cameras may also consume high amounts of power, which, for example, may be problematic for mobile devices that have a limited power supply.

The present disclosure describes various techniques for implementing a three-dimensional interface. In one embodiment, a device is disclosed that includes a camera and a proximity sensor. In some embodiments, the device may be a computing device such as a notebook, mobile phone, tablet, etc. In other embodiments, the device may be an external device that can be plugged into a computing device. In various embodiments, the camera is configured to capture an image that includes an object, and the proximity sensor is configured to perform a measurement operation that includes determining only a single distance value for the object (as opposed to determining multiple distances values during a single instant in time or simultaneously). In some instances, the object may be a hand of a user that is interacting with the device by, for example, moving around objects in a three-dimensional environment. In various embodiments, the device is configured to calculate a location of the object based on the measured distance and the captured image. In some embodiments, the device is configured to determine a location of the object even when the object is in close proximity to the device (e.g., within one meter). The device may also be configured to determine multiple locations of the object over time to determine a path of motion as the object moves—e.g., in some embodiments, a user may select items on a display by making different motions with a hand.

The present disclosure also describes various power-saving techniques that may be implemented by the device using the camera and proximity sensor. In one embodiment, the device may shut down the camera when no object is present for detection. When the proximity sensor subsequently detects motion in the form of a varying position (e.g., due to movement of a user's hand), the device may wake up the camera and use the camera to further analyze the object (e.g., to determine a particular gesture of the hand to decide what to do—such as awaking additional components responsive to a “thumbs up” gesture). By disabling and enabling the camera in this manner, the device, in some embodiments, is able to save power using only the proximity sensor while still being able to detect high-resolution gestures when the camera is needed.

In many instances, the embodiments described herein provide a better alternative to existing three-dimensional interfaces by providing a more cost-effective and/or lower power-consuming solution.

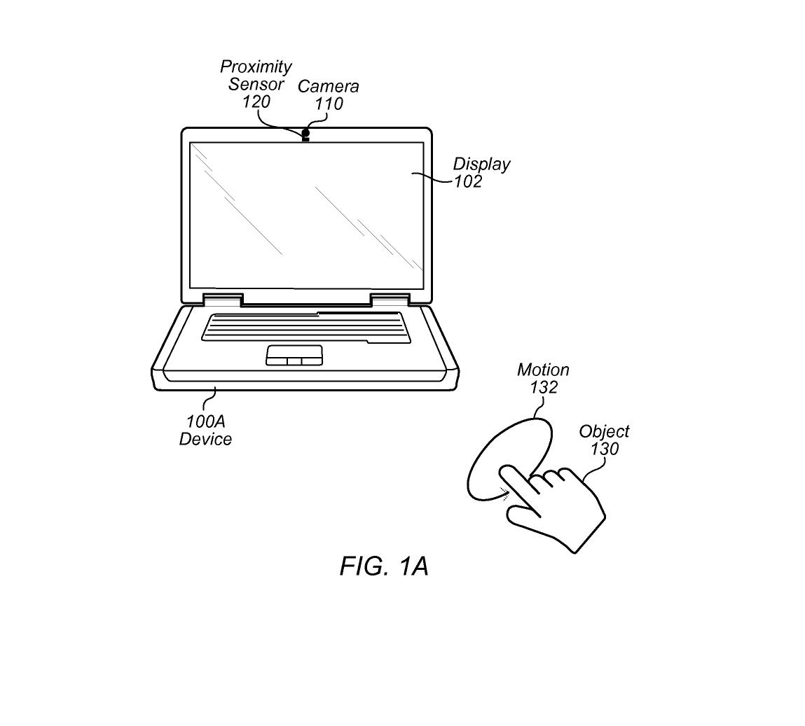

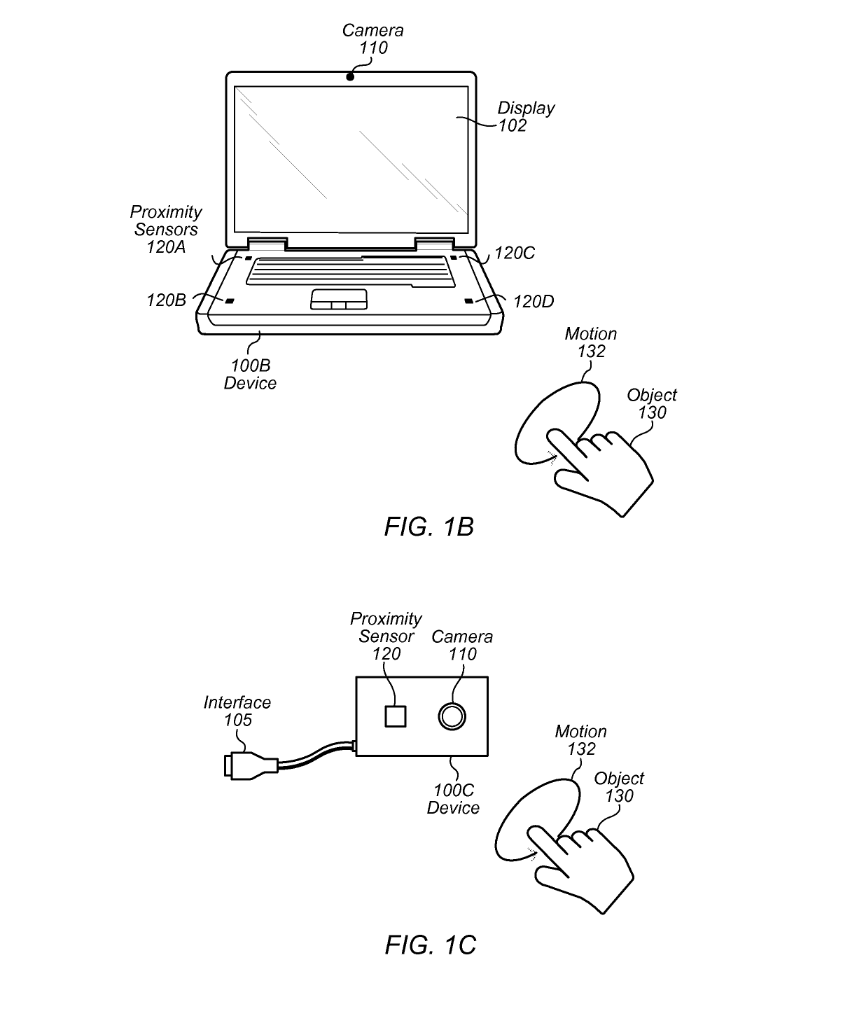

Turning now to FIG. 1A, a block diagram of device 100A is depicted. Device 100A is one embodiment of a device that is configured to implement a three-dimensional computer interface. In the illustrated embodiment, a camera 110 and a proximity sensor 120 are integrated into device 100A. Device 100A also includes a display 102. As will be described below, in various embodiments, device 100A is configured to calculate a location of object 130 based on an image captured by camera 110 and a distance measured by proximity sensor 120. Device 100A may also be configured to interpret one or more calculated locations as commands to control one or more operations.

Device 100A may be any suitable type of computing device. In some embodiments, device 100A is a personal computer such as a desktop computer, laptop computer, netbook computer, etc. In some embodiments, device 100A is a portable device such as a mobile phone, tablet, e-book reader, music player, etc. In one embodiment, device 100A may be a gaming console. In another embodiment, device 100A may be a car's computer system (or an interface to such a system), which analyzes inputs from a driver to control a sound system, navigation system, phone system, etc.

Camera 110 may be any suitable type of camera that is configured to capture two-dimensional images including an object 130. In some embodiments, camera 110 may be a camcorder, webcam, phone camera, digital camera, etc. In one embodiment, camera 110 may be a dash camera integrated into the dash of a car. In some embodiments, camera 110 may capture black and white images, color images, infrared images, etc.

Proximity sensor 120 may be any suitable type of sensor that is configured to measure a distance to an object 130. In various embodiments, sensor 120 is a low-resolution detector configured to sense the presence and position of an object 130 while camera 110 provides higher resolution 2D images from which object 130 can be recognized and classified. In some embodiments, proximity sensor 120 is configured to perform a measurement operation that includes determining only a single distance value for the object. In such embodiments, sensor 120 stands in contrast to proximity camera devices (such as an infrared depth camera), which capture a higher resolution map of multiple depths as opposed to merely giving an indication of whether an object 130 is nearby and an approximation of how close it is to the detector. For example, in one embodiment, sensor 120 is an electromagnetic sensor that is configured to emit an electromagnetic field (e.g., using a coil) and to measure a single distance value by measuring a frequency or phase shift in the reflected field (a theremin is one example of a device that uses a electromagnetic sensor). In another embodiment, sensor 120 is an acoustic proximity sensor that is configured to emit a high-frequency sound and to measure a distance by measuring its echo. In yet another embodiment, sensor 120 is an infrared depth sensor (not to be confused with an infrared depth camera) configured to emit light and measure a distance based on how quickly the light is reflected (such a sensor may be similar to those used in backup-collision warning systems found in cars).

Object 130 may be any suitable type of object usable to provide an input to device 100A (or devices 100B and 100C described below). In some embodiments, object 130 may be a body part such as a user's hands, arms, legs, face, etc. In some embodiments, object 130 may be an object manipulated by a user such as a stylus, ball, game controller, etc. In various embodiments, object 130 may be one of several objects being tracked by device 100A.

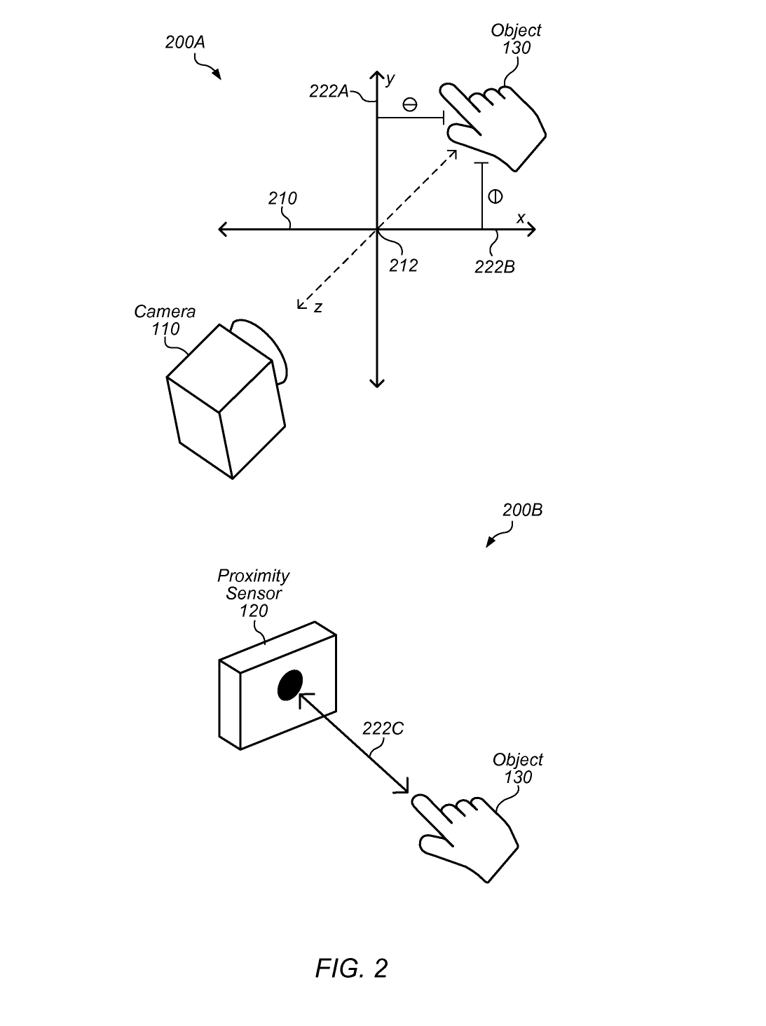

As noted above, in various embodiments, device 100A is configured to calculate a location of object 130 based on an image captured by camera 110 and a distance measured by proximity sensor 120. To calculate a location, device 100A may use any of a variety techniques, such as those described below in conjunction with FIG. 2. In some embodiments, device 100A includes a processor and memory that stores program instructions (i.e., software) that are executable by the processor to calculate a location of object 130. In another embodiment, device 100A includes logic (i.e., circuitry) that is dedicated to calculating a location of object 130 from a captured image and a measured distance. The logic may be configured to provide calculated locations (and other information, in some embodiments) to software for further processing, e.g., via a driver.

Device 100A may be further configured to determine a motion 132 of an object 130 by calculating multiple locations as an object 130 moves over time. In one embodiment, device 100A is configured to determine a direction of the motion 132, and to distinguish between different directions—e.g., whether an object 130 is moving toward, away from, or across device 100A. In one embodiment, device 100A is configured to determine a speed of the object. For example, device 100A may be configured to distinguish between a quick movement of a user's hand and a slower movement. In some embodiments, device 100A is configured to determine a type of motion 132 from calculated locations. For example, device 100A may be configured to distinguish between a back-and-forth motion, a circular motion, a hook motion, etc.

Device 100A may be further configured to identify a type of object 130. For example, in some embodiments, device 100A is configured to identify whether an object 130 is a user's hand, face, leg, etc. based on a captured image. In various embodiments, device 100A is configured to identify multiple objects 130 and track the location of each object independently. In some embodiments, device 100A is configured to ignore non-recognized objects or objects indicated as not being important (e.g., in one embodiment, a user may indicate that objects should not be tracked if they are not a hand, face, or other human body part).

Device 100A may be further configured to identify a type of gesture being made based on one or more captured images. For example, in some embodiments, device 100A may be configured to identify an object 130 as a user's hand, and to determine whether the user is making a pointing gesture, a fist gesture, a thumbs-up gesture, a horns gesture, etc. In some embodiments, devices 100A may also be configured to identify gestures with other body parts, such as whether a user's face is smiling, frowning, etc.

In various embodiments, device 100A is configured to interpret various ones of such information as commands to control one or more operations. Accordingly, in one embodiment, device 100A is configured to interpret different locations of object 130 as different commands—e.g., a first command if object 130 is close to device 100A and a second command if object 130 is in the distance. In one embodiment, device 100A is configured to interpret different motions 132 as different commands—e.g., a first command associated with a quick motion and a second command associated with a slow motion. In one embodiment, device 100A is configured to associate different commands with different objects—e.g., a first command if object 130 is recognized as a user's face and a second command if object 130 is recognized as a user's leg. In one embodiment, device 100A is configured to interpret different gestures as different commands—e.g., a first command for a thumbs-up gesture and a second command for a pointing gesture.

Device 100A may be configured to control any of a variety of operations based on such commands. In one embodiment, device 100A is configured to control the movement of objects in a three-dimensional environment (e.g., chess pieces on a chess board). In one embodiment, device 100A is configured to control a selection of items from a menu. For example, device 100A may be configured to interpret a pointing gesture as a selection command (e.g., to pick an item on a menu) and an open palm as a de-selection command (e.g., to drop an item on a menu). In one embodiment, device 100 may be configured to control the actions of a character in a game—e.g., jumping, running, fighting, etc.

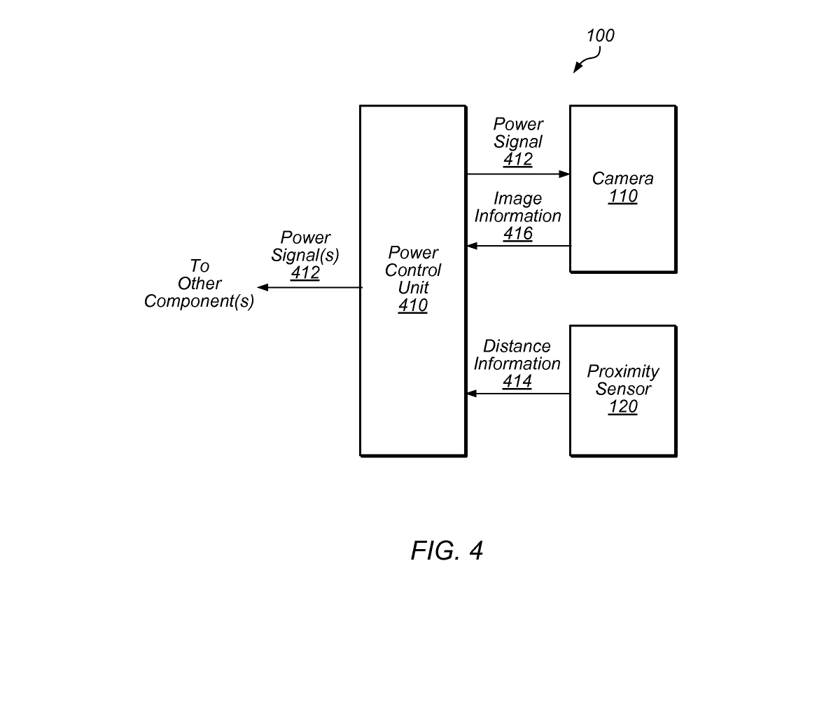

In various embodiments, device 100A is configured to manage power consumption based on information received from camera 110 and/or sensor 120. In one embodiment, device 100A is configured to disable camera 110 (i.e., enter a lower power state in which certain functionality may be disabled) if device 100A is unable to detect the presence of an object 130 for a particular period (e.g., as specified by a user). Device 100A may be configured to continue providing power to sensor 120, however. In such an embodiment, if sensor 120 subsequently detects the presence of an object 130, device 100A is configured to enable camera 110 (i.e., enter a higher power state in which the device is operational). Device 100A may then resume tracking locations of an object 130 with both camera 110 and proximity sensor 120. In some embodiments, devices 100A may be configured to disable and enable other components as well, such as display 102, other I/O devices, storage devices, etc. In one embodiment, device 100A may be configured to enter a sleep mode in which device 100A may change the power and/or performance states of one or more processors. Device 100A may be configured to wake from the sleep mode upon subsequently detecting the presence of an object 130. Various power saving techniques are described in further detail in conjunction with FIG. 4.

Turning now to FIG. 1B, a block diagram of another device 100B is depicted. Device 100B is one embodiment of device that is configured to use multiple proximity sensors to implement a three-dimensional computer interface. In the illustrated embodiment, multiple proximity sensors 120A-D are embedded in a keyboard and palm rest of device 100B. As noted above, sensors 120 may be located in any suitable location. Sensors 120 may also be any suitable type such as those described above. In some embodiments, sensors 120 may also include different types of sensors—e.g., ones of sensors 120 may be electromagnetic sensors while others may be infrared sensors. In various embodiments, device 100B may be configured to function in a similar manner as device 100A.

Turning now to FIG. 1C, a block diagram of yet another device 100C is depicted. Device 100C is another embodiment of a device that is usable to implement a three-dimensional computer interface. In the illustrated embodiment, device 100C includes an interface 105, camera 110, and proximity sensor 120. In various embodiments, device 100C may be configured to function in a similar manner as device 100A. Unlike device 100A, device 100C is a separate device that may be coupled to a computing device via interface 105 in various embodiments.

Interface 105 may be any suitable interface. In some embodiments, interface 105 may be a wired interface, such as a universal serial bus (USB) interface, an IEEE 1394 (FIREWIRE) interface, Ethernet interface, etc. In other embodiments, interface 105 may be a wireless interface, such as a WIFI interface, BLUETOOTH interface, IR interface, etc. In one embodiment, interface 105 may be configured to transmit captured images and measured distances, which are processed and interpreted into commands by another device. In other embodiments, interface 105 may be configured to transmit processed information (e.g., calculated locations, determined motions, identified gestures, etc.) and/or commands to another device. In such embodiments, device 100C may include logic (or a processor and memory) to process captured images and measured distances.

Turning now to FIG. 2, a set of diagrams 200A and 200B illustrating operation of camera 110 and proximity sensor 120 in one embodiment are depicted. In diagram 220A, camera 110 is capturing an image of a three-dimensional space that includes an object 130. Three-dimensional space is represented by a set of axes 210, which are labeled as x, y, and z. In diagram 220B, proximity sensor 120 is measuring a distance to the object 130. In the illustrated embodiment, the distance may be measured along the z axis in diagram 200A.

As noted above, devices 100 may be configured to calculate a location of an object 130 by using any of a variety of techniques. In the illustrated embodiment, devices 100 are configured to determine a location of object 130 in an x, y plane from a captured image, by determining an elevation angle φ 222A and an azimuth angle θ 222B of object 130 relative to an origin 212. For example, devices 100 may determine that object 130 is 5° above and 7° to the right of origin 212. In some embodiments, devices 100 may convert these angles to distance once a distance 222C is measured by sensor 120 (e.g., that object 5″ above and 7″ to the right of origin). In one embodiment, devices 100 may be configured to determine a location of object 130 in an x, y plane by assigning a set of boundaries for an image (e.g., a width of 200 pixels and a height of 100 pixels; pixel 0,0 being located in the upper left-hand corner, in one embodiment) and determining a location within that boundary (e.g., object 130's center is at pixel 150, 25). Devices 100 may be configured to then combine this information with a measured distance 222C to calculate the location of object 130 within the three-dimensional space. In various embodiments, devices 100 may express a location using any of a variety of coordinate systems such as the Cartesian coordinate system, spherical coordinate system, parabolic coordinate system, etc.

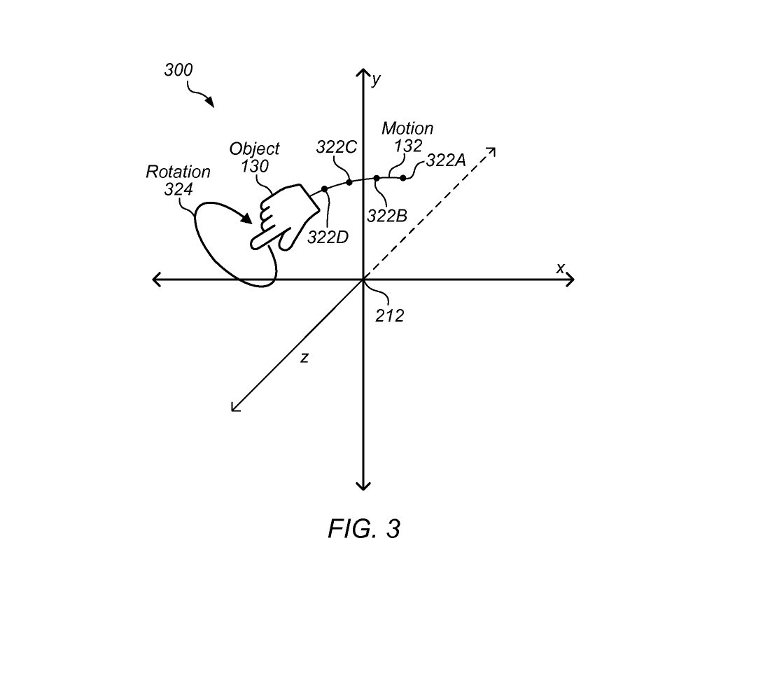

Turning now to FIG. 3, a diagram 300 illustrating an exemplary path of motion for an object is depicted. In diagram 300, object 130 is a hand that has a motion 132 passing through locations 322A-D. Object 130 is also performing a rotation 324 during movement 132. In one embodiment, diagram 300 may be representative of a user that is making a section by moving his or her hand forward to point at a particular item. In one embodiment, camera 110 and sensor 120 may be positioned along the z axis to capture images of and measure distances to object 130. In various embodiments, devices 100 may determine the movement 132 by calculating locations 322A-D from captured images and measured distances at each location 322.

As noted above, devices 100 may also determine a variety of other information about motion 132. In one embodiment, devices 100 may determine an average speed for motion 132 by determining the distances between locations 322 and dividing by the time taken to make motion 132—e.g., object 130 is moving a meter every three seconds. In one embodiment, devices 100 may determine a direction from locations 322—e.g., that object 130 is moving forward along the z axis. In one embodiment, devices 100 may determine an axis of rotation and/or a speed of rotation based on multiple captured images—e.g., that object 130 is rotating at 45° per second about an axis passing through the center of object 130. As discussed above, devices 100 may interpret various ones of this information as commands to control one or more operations.

Turning now to FIG. 4, a block diagram illustrating one embodiment of a power control unit 410 is depicted. As noted above, devices 100 may be configured to manage power consumption based on information received from camera 110 and/or sensor 120. In the illustrated embodiment, a device 100 includes a power control unit 410 to facilitate this management.

Power control unit 410, in one embodiment, is configured to enable and disable one or more components in device 100 (e.g., camera 110) via a power signal 412. In some embodiments, a power signal 412 may be a command instructing a component to disable or enable itself. In some embodiments, power signal 412 may be a supplied voltage that powers a component. Accordingly, power control unit 410 may disable or enable a component by respectively reducing or increasing that voltage. In some embodiments, power signal 412 may be a clock signal, which is used to drive a component.

Power control unit 410 may be configured to enable and disable components based on distance information 414 received from proximity sensor 120. In one embodiment, power control unit 410 is configured to enable or disable components based on whether distance information 414 is specifying a measured distance, which is changing. For example, power control unit 410 may disable camera 110 when distance information 414 specifies the same measured distance for a particular amount of time (e.g., indicating that no moving object 130 may be present). Power control unit 410 may subsequently enable camera 110 once a measured distance begins to change (e.g., indicating that a moving object 130 appears to be present). In another embodiment, power control unit 410 is configured to enable or disable components in response to distance information 414 specifying a measured distance within a particular range. For example, power control unit 410 may disable camera 110 when a measured distance is greater than a particular value—e.g., a few feet.

Power control unit 410 may be configured to enable and disable components based on image information 416 received from camera 110. As noted above, device 100 may be configured to identify objects 130 present in an image captured by camera 110. In one embodiment, power control unit 410 is configured to disable one or more components (e.g., display 102) if device 100 is unable to recognize any of a set of objects 130 (e.g., body parts of a user) from image information 416. Accordingly, power control unit 410 may be configured to enable one or more components if device 100 is subsequently able to recognize an object 130 (e.g., a user's hand) from image information 416.

In some embodiments, power control unit 410 is configured to enable and disable components based on both distance information 414 and image information 416. In one embodiment, power control unit 410 is configured to disable a set of components including camera 110 in response to determining that no object 130 is present. Power control unit 410 may continue to receive distance information 414 while camera 110 is disabled. Upon distance information 414 indicating the presence of an object 130, power control unit 410, in one embodiment, is configured to enable camera 110 to begin receiving image information 416. In one embodiment, if device 100 then recognizes a particular object 130 (e.g., object 130 is recognized as a user's hand), power control unit 410 is configured to further enable one or more additional components that were previously disabled. Accordingly, power control unit 410 may enable one or more components including camera 110 during a first phase based merely on distance information 414, and may enable one or more additional components during a second phase based on both distance information 414 and image information 416 indicating the presence of a particular object 130. In some embodiments, power control unit 410 is configured to enable devices in this second phase in response to not only recognizing a particular object 130, but also determine that the object 130 is making a particular motion or gesture. For example, power control unit 410 may turn on camera 110 in response to detecting an object 130 and then turn on additional components in response to determining that the object 130 is a user's hand and that the hand is performing a waving motion.

In some embodiments, power control unit 410 is further configured to cause device 100 to enter or exit a sleep mode based on information 414 and/or information 416. In one embodiment, power control unit 410 may cause device 100 to enter a sleep when determining that no object 130 is present. During this low power state, proximity sensor 120 is still active since it may consume very little power (in the micro-watts during idle, in one embodiment). Upon detecting the presence of an object 130 such as a user's hand with a specific motion, power control unit 410 may be configured to then wake the rest of the system.

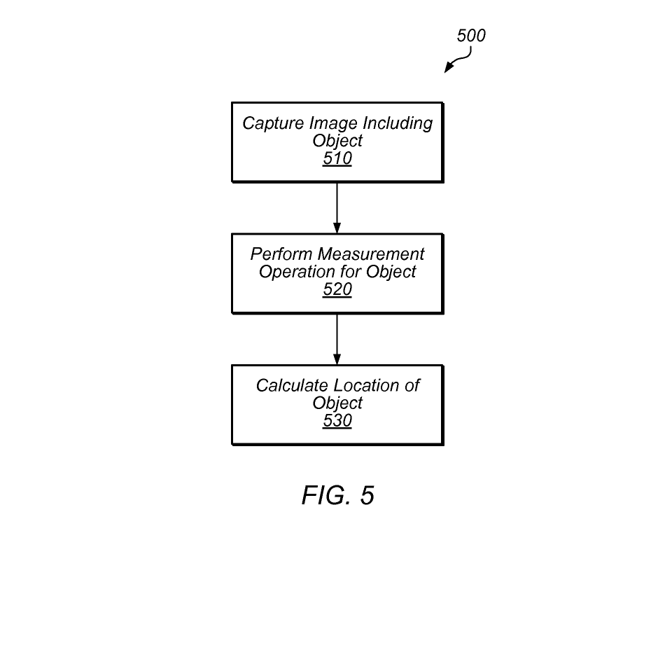

Turning now to FIG. 5, a flow diagram of a method 500 for calculating the location of an object is depicted. Method 500 is one embodiment of a method that may be performed by a device, such as devices 100. In some instances, performing method 500 may provide a more cost-effective and/or lower power-consuming solution for determining a location than using traditional three-dimensional interfaces such as ones that use a stereoscope.

In step 510, device 100 (e.g., using camera 110) captures an image that includes an object 130. As discussed above, device 100 may use any of a variety of cameras. In one embodiment, device 100 uses a single webcam. In some embodiments, the image may also be in color, black and white, infrared, etc.

In step 520, device 100 (e.g., using proximity sensor 120) performs a measurement operation that includes determining only a single distance value for object 130, the single distance value being indicative of a distance to the object 130. As discussed above, device 100 may use any of a variety of proximity sensors to measure a distance to the object 130. In one embodiment, device 100 uses an electromagnetic proximity sensor. In some embodiments, device 100 is further configured to determine the single distance value when the object is within 1 m of device 100 (or more specifically, within 1 m of sensor 120).

In step 530, device 100 calculates a location of the object 130 based on the captured image and the measured distance. In one embodiment, device 100 calculates the location by determining an elevation angle (e.g., angle φ 222A) and an azimuth angle (e.g., angle θ 222B) of the object 130 from the captured picture and calculating a coordinate set (e.g., a set of Cartesian coordinates including an x-axis coordinate, a y-axis coordinate, and a z-axis coordinate) representative of the location of the object 130 based on the measured distance. In various embodiments, device 100 calculates the locations of multiple objects 130 simultaneously (e.g., an image captured in step 510 may include multiple objects 130). As discussed above, device 100 may calculate additional information about the object 130. For example, in one embodiment, device 100 determines a motion of the object including a direction and a speed from multiple calculated locations. In one embodiment, device 100 identifies the type of object and determines a gesture of the object (e.g., the object is a hand, and the hand is making a pointing gesture.)

As discussed above, device 100 may also interpret such information into commands to control one or more operations. For example, in one embodiment, device 100 shows a set of items on a display (e.g., display 102) and interprets information determined from captured images and measured distances as commands to move items on the display. As another example, in one embodiment, device 100A may be configured to interpret a pointing gesture as a selection command (e.g., to pick an item on a menu) and an open palm as a de-selection command (e.g., to drop an item on a menu). In one embodiment, device 100 may be configured to control the actions of a character in a game—e.g., jumping, running, fighting, etc.

As discussed above, in some embodiments, device 100 may include a control unit (e.g., power control unit 410) to disable components (such as the camera) after not detecting a presence of an object for a particular period of time and to enable those components after detecting the presence of an object—e.g., based on distance information (e.g., distance information 414) received from the proximity sensor and/or image information (e.g. image information 416) received from the camera. In some embodiments, device 100 may initially enable the camera to capture image information (e.g., image information 416) before enabling other components. Device 100 may enable the other components once it has recognized, from the image information, that the object is one of a particular set (e.g., a set of body parts) and/or that object is making a particular gesture.

### Exemplary Computer System

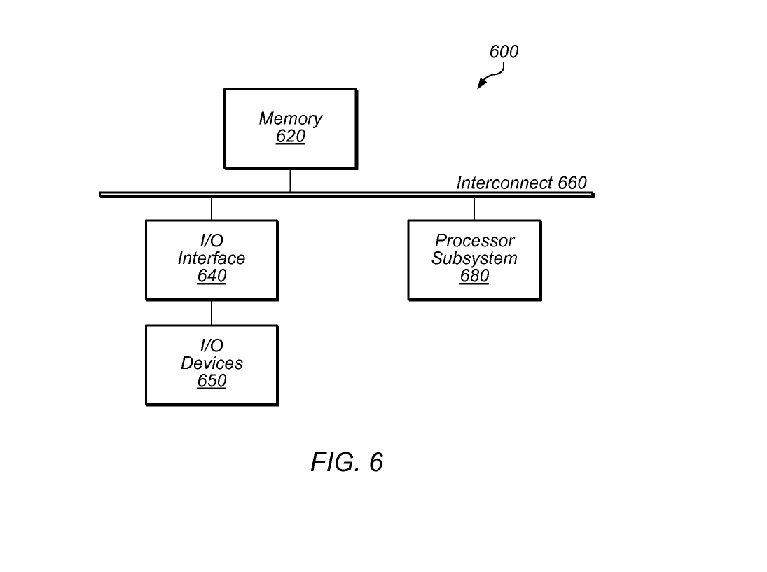

Turning now to FIG. 6, a block diagram of an exemplary computer system 600 is depicted. Computer system 600 is one embodiment of a computer system that may be used to implement a device such as devices 100A and 100B or may be coupled to a device such as device 100C. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Computer system 600 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 600 may also be any type of networked peripheral device such as storage devices, switches, modems, routers, etc. Although a single computer system 600 is shown for convenience, system 600 may also be implemented as two or more computer systems operating together.

Processor subsystem 680 may include one or more processors or processing units. For example, processor subsystem 680 may include one or more processing units (each of which may have multiple processing elements or cores) that are coupled to one or more resource control processing elements 620. In various embodiments of computer system 600, multiple instances of processor subsystem 680 may be coupled to interconnect 660. In various embodiments, processor subsystem 680 (or each processor unit or processing element within 680) may contain a cache or other form of on-board memory.

System memory 620 is usable by processor subsystem 680. System memory 620 may be implemented using different physical memory media, such as hard disk storage, floppy disk storage, removable disk storage, flash memory, random access memory (RAM—static RAM (SRAM), extended data out (EDO) RAM, synchronous dynamic RAM (SDRAM), double data rate (DDR) SDRAM, RAMBUS RAM, etc.), read only memory (ROM—programmable ROM (PROM), electrically erasable programmable ROM (EEPROM), etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device.

Program instructions that are executed by computer systems (e.g., computer system 600) may be stored on various forms of computer readable storage media (e.g., software to calculate the location of an object 130). Generally speaking, a computer readable storage medium may include any non-transitory/tangible storage media readable by a computer to provide instructions and/or data to the computer. For example, a computer readable storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. An apparatus, comprising:
a camera configured to capture a two-dimensional image that includes an object; and
a sensor configured to perform a measurement operation that includes determining only a single distance value for the object, wherein the single distance value is indicative of a distance to the object;
wherein the apparatus is configured to calculate a location of the object based on the captured image and the single distance value.

2. The apparatus of claim 1, wherein the sensor is configured to determine the single distance value when the object is within 1 m of the sensor.

3. The apparatus of claim 1, wherein the apparatus is configured to determine a motion of the object by performing a plurality of measurement operations, and wherein the apparatus is configured to control one or more operations of the apparatus based on the determined motion.

4. The apparatus of claim 3, further comprising:
a display configured to depict content; and
wherein the apparatus is configured to identify the object as a user's hand, and wherein the apparatus is configured to control a depiction of the content on the display based on the determined path of motion for the user's hand.

5. The apparatus of claim 4, wherein the apparatus is configured to identify a gesture of the user, and to further control the depiction of content based on the identified gesture.

6. The apparatus of claim 1, further comprising:
a control unit configured to enable and disable the camera; and
wherein the apparatus is configured to detect the presence of the object based on a change in the single distance value over time, and wherein the apparatus is configured to instruct the control unit to enable the camera in response to detecting the presence of the object.

7. The apparatus of claim 1, further comprising:
a keyboard configured to provide an input to the apparatus, wherein the sensor is one of a plurality of proximity sensors embedded in the keyboard, and wherein the sensor is an electromagnetic proximity sensor.

8. A method, comprising:
a device capturing an image that includes an object located within 1 m of the device; and
the device using a sensor to perform a measurement operation in which only a single distance to the object is determined;
the device calculating a location of the object based on the captured image and the single distance.

9. The method of claim 8, further comprising:
the device determining a motion of the object; and
interpreting the determined motion as a command for an operation.

10. The method of claim 8, further comprising:
the device determining a gesture of a user; and
the device interpreting the determined gesture as a command for an operation.

11. The method of claim 10, further comprising:
the device showing a set of items on a display, and wherein the command is to move one of the items on the display.

12. The method of claim 8, further comprising:
the device disabling the camera after not detecting a presence of the object for a particular period of time; and
the device enabling the camera based on a plurality of measurement operations performed by the sensor.

13. The method of claim 12, wherein the disabling includes disabling one or more additional components, and wherein the method further comprises:
the device initially enabling the camera to capture image information; and
the device subsequently enabling the one or more additional components based on the image information.

14. The method of claim 13, wherein the devices subsequently enables the one or more additional components in response to recognizing the object as a user's hand and determining that the user's hand is making a particular gesture.

15. An apparatus, comprising:
a camera configured to capture an image that includes an object;
an electromagnetic proximity sensor configured to measure a distance to the object; and
wherein the apparatus is configured to calculate a location of the object based on the captured image and the measured distance.

16. The apparatus of claim 15, wherein the apparatus is further configured to calculate a location of the object when the object is within 1 m of the proximity sensor.

17. The apparatus of claim 15, wherein the calculated location is a Cartesian-coordinate set representative of the location of the object.

18. The apparatus of claim 15, wherein the apparatus is further configured to:
determine a motion of the object including a speed and a direction of the motion; and
interpret the speed and the direction as a command for an operation.

19. The apparatus of claim 15, wherein the apparatus is further configured to:
disable the camera in response to not detecting a presence of the object for a particular period of time.

20. The apparatus of claim 19, wherein the apparatus is further configured to:
enter a sleep mode in response to not detecting the presence of the object for the particular period of time.
